(19) United States
(12) Patent Application Publication
(10) Pub. No.: US 2026/0350044 A1
(43) Pub. Date: Nov. 5, 2026

(54) METHODS AND SYSTEMS FOR SPARSE LATE INTERACTION RETRIEVAL

(71) Applicant: NAVER CORPORATION, Seongnam-si (KR)

(72) Inventors: Stéphane CLINCHANT, Meylan (FR); Hervé DEJEAN, Grenoble (FR); Thibault FORMAL, Saint-Ouen-sur-Seine (FR)

(21) Appl. No.: 19/575,137

(22) Filed: Mar. 23, 2026

Related U.S. Application Data
(60) Provisional application No. 63/791,807, filed on Apr. 21, 2025.

(51) Int. Cl. G06F 16/31

(52) U.S. Cl. CPC G06F 16/313

(57) ABSTRACT

In a computer-implemented method of late interaction information retrieval from a corpus of documents, embedded context representations of tokens of an input sequence are received, which are generated by a dense pretrained language model (PLM). A sparse representation is encoded from the embedded context representations using a trained head coupled to the dense PLM. The encoded sparse representation is compared to a sparse index to generate candidate documents from the corpus of documents.

### PRIORITY CLAIM

This application claims priority to and the benefit of U.S. Provisional Application Ser. No. 63/791,807, filed Apr. 21, 2025, which application is incorporated in its entirety by reference herein.

### FIELD

The present disclosure relates generally to machine learning, and more particularly to methods and systems incorporating neural language models for information retrieval.

### BACKGROUND

It is useful to provide IR (Information Retrieval) methods in which online inference is fast. Learning dense embeddings to conduct retrieval using efficient approximate nearest neighbors (ANN) methods has shown good results, but such methods are typically still combined with BoW (Bag of Words) models (e.g., combining both types of signals) due to their inability to explicitly model term matching.

Information Retrieval systems often aim to return a ranked list of documents ordered with respect to their relevance to a user query. However, configurations of IR systems can involve significant complexity. For example, current IR systems such as web search engines typically use several retrieval models, which are specialized in diverse information needs such as different search verticals. Further, IR systems usually are multi-stage, including a first stage retriever and a second stage reranker. Such multi-stage retrieval is configured to consider a tradeoff between effectiveness and efficiency, in which the first stage retrievers are configured for fast retrieval of potentially relevant candidate documents from a large corpus, and the rerankers focus on effectiveness.

There have been efforts to use learned (neural) rankers for first-stage retrievers to address issues such as the vocabulary mismatch problem, in which relevant documents might not contain terms that appear in the query. Pretrained language models (PLMs) such as those based on Bidirectional Encoder Representations from Transformers (BERT)-based LMs are popular for natural language processing (NLP) and for re-ranking tasks in information retrieval. PLM-based neural models have shown a strong ability to adapt to various tasks by simple fine-tuning. Dense retrieval based on BERT models is a standard approach for candidate generation in question answering and information retrieval tasks.

Rich term embeddings can be provided by PLMs such as BERT where documents are represented by tokens in a particular vocabulary space.

PLM-based ranking models can provide improved results for passage re-ranking tasks, but such models introduce challenges of efficiency and scalability.

Because of practical efficiency requirements, PLM-based models conventionally have been used only as re-rankers in a two-stage ranking pipeline, while a first stage retrieval (or candidate generation) is conducted with BoW models that rely on inverted indexes or term-based approaches such as BM25 for first-stage ranking.

U.S. patent application Ser. No. 17/804,983, filed May 5, 2023, published as U.S. Patent Pub. No. 2023/0214633 on Jul. 6, 2023, U.S. patent application Ser. No. 18/312,703, filed May 5, 2023, published as U.S. Patent Pub. No. 2023/0418848 on Dec. 8, 2023, and U.S. patent application Ser. No. 18/417,335, filed Jan. 19, 2024, each of which are incorporated herein by reference, disclose use of sparse information retrieval models (also referred to as SPLADE models) based on PLMs, in which queries and optionally documents are encoded in a sparse high-dimensional latent space for a first-stage retriever and optionally a second stage reranker. Neural ranker models (rankers) are provided for document ranking in information retrieval (IR) by generating vector representations that are sparse enough to allow the use of inverted indexes for retrieval. Such methods are faster and more reliable than methods such as approximate nearest neighbor (ANN) methods, and enable exact matching, while performing comparably to neural IR representations using dense embedding.

### SUMMARY

Embodiments herein provide, among other things, a computer-implemented method of late interaction information retrieval from a corpus of documents.

Embedded context representations of tokens of an input sequence are received where the embedded context representations are generated by a dense pretrained language model (PLM). A sparse representation of the input sequence is encoded from the embedded context representations using a trained head coupled to the dense PLM. The encoded sparse representation is compared to a sparse index to generate candidate documents from the corpus of documents, wherein the sparse index stores encoded sparse representations of documents in the corpus of documents. The generated candidate documents are output to one or more of an audible device, a display device, a storage device, and a downstream task.

Methods may further comprise reranking the candidate documents using the embedded context representations from the dense PLM.

Additional embodiments provide a method, e.g., performed by one or more processors, for training an encoder for encoding an input sequence for late interaction information retrieval. A head is coupled to a dense pretrained language model (PLM) to provide the encoder, where the head comprises an adapter, a logit layer, and a pooling layer. The dense PLM is frozen, and the head is trained on an information retrieval task to update parameters of the trained head. The training comprises, for a dataset of input sequences: the dense PLM receiving the input sequence and embedding context representations of tokens of the input sequence; the head encoding a sparse representation of the input sequence from the embedded context representations; and updating parameters of the head to optimize the encoder to approximate the dense PLM.

Additional embodiments provide a system, e.g., implemented by one or more processors, for encoding an input sequence comprising: a dense backbone PLM trained to embed context representations of tokens of the input sequence; and a sparse encoder coupled to the PLM and trained to encode a sparse representation of the input sequence from the embedded context representations using a trained head. The sparse encoder comprises: an adapter configured to receive and process the embedded context representations, the adapter comprising a trained multilayer perceptron (MLP); a logit layer configured to receive the processed context representations and the embedded context representations and map the embedded context representations to a vocabulary; and a pooling layer configured to generate a sparse representation of the input sequence over the vocabulary from an output of the logit layer. The sparse encoder is trained while coupled to the PLM and while the PLM is frozen. A candidate generation module may include the encoding system; a sparse index storing sparse representations of documents; a comparator for comparing the encoded input sequence to sparse representations of documents stored in the sparse index to generate candidate documents from the corpus of documents; and an output device providing the candidate documents by one or more of (a) audibly via at least one speaker and (b) visually via at least one display. An end-to-end information retrieval system may include the candidate generation module and a reranking module coupled to the candidate generation module. The reranking module may process the generate candidate documents using the embedded context representations of the input sequence.

According to a complementary aspect, the present disclosure provides a computer program product, comprising code instructions to execute a method according to the previously described aspects; and a computer-readable medium, on which is stored a computer program product comprising code instructions for executing a method according to the previously described embodiments and aspects. The present disclosure further provides a processor configured using code instructions for executing a method according to the previously described embodiments and aspects.

Other features and advantages of the invention will be apparent from the following specification taken in conjunction with the following drawings.

### DESCRIPTION OF THE DRAWINGS

The accompanying drawings are incorporated into the specification for the purpose of explaining the principles of the embodiments. The drawings are not to be construed as limiting the invention to only the illustrated and described embodiments or to how they can be made and used. Further features and advantages will become apparent from the following and, more particularly, from the description of the embodiments as illustrated in the accompanying drawings, wherein:

FIG. 1 shows an example system using a neural network model for information retrieval (IR) of documents.

FIG. 2 shows an example input sequence (i.e., document or query) encoding method according to embodiments.

FIG. 3 shows an example method for mapping context embedded tokens to a vocabulary performed by a trained head coupled to a dense pretrained language model (PLM) according to embodiments.

FIG. 4 illustrates an example document encoding system and training method according to embodiments that can rely on the same representations from a dense backbone PLM (hᵢ)_{i∈t} to learn sparse BoW with a sparse encoding module (as shown, SPLADE module) for candidate generation, and to compute late interactions for reranking.

FIG. 5 shows an example head adapter including multilayer perceptron (MLP) layers.

FIG. 6 shows an example pooling method for generating a sparse representation of a document.

FIG. 7 illustrates an example information retrieval system and inference method according to embodiments in which an adapted dense backbone PLM, ColBERT v2, maps representations of query tokens to a sparse vector, which is used to retrieve k documents from a precomputed sparse index (R setting). In an end-to-end (e2e) setting, representations are gathered from the PLM backbone (here, ColBERT) index to re-rank the candidates exactly with MaxSim (summation of Maximum Similarity).

FIG. 8 shows an example inference, e.g., information retrieval, method that may be performed by the example information retrieval system of FIG. 7.

FIG. 9 shows candidate generation approximate accuracy on MS MARCO dev—SPLATE (R) in illustrative experiments. Dotted lines represent R(10), and solid lines represent R(100).

FIG. 10 shows impact of k and (k_{q},k_{d}) on SPLATE (e2e) out-of-domain performance in experiments—Success@5 on LoTTE (test pooled Search). Line 1002 represents ColBERTv2.

FIG. 11 illustrates experimental examples of predicted BoW for queries in MS MARCO dev.

FIG. 12 shows an example architecture in which example methods can be implemented.

In the drawings, reference numbers may be reused to identify similar and/or identical elements.

### DETAILED DESCRIPTION

### Introduction

For neural retrieval models based on pretrained language models (PLMs), the multi-vector (dense) or late interaction approach, introduced with the ColBERT model, as disclosed in Khattab and Zaharia, ColBERT: Efficient and effective passage search via contextualized late interaction over BERT. In Proc. SIGIR, pages 39-48, 2020, has delivered favorable results across many benchmarks. Efficient late interaction retrieval is based on an optimized multi-step approach or pipeline, where an approximate search first identifies a set of candidate documents based on approximate scores (candidate generation), and the documents are then re-ranked exactly. ColBERT offers a useful effectiveness-efficiency tradeoff across various benchmarks. As opposed to conventional retrieve-and-rank pipelines in information retrieval, late interaction retrieval uses the same model, e.g., a PLM, for both retrieval and ranking. By contrast, a standard DPR>>MonoBERT pipeline, for instance, requires feeding a query twice to a PLM at inference time. In practical deployments, such repeated transformer inference and multi-stage processing can increase query-time latency and compute consumption, particularly for large-scale or real-time retrieval workloads.

Late interaction modules offer advantages over models such as cross-encoders because they allow for pre-computation of document representations offline, thus potentially improving efficiency. However, such advantages come at the expense of storing large indexes of dense term representations. Accordingly, the space footprint and memory-bandwidth demands of storing and searching dense, per-token representations can constrain scalability and limit deployment on resource-constrained and/or CPU (central processing unit)-only systems.

Variants of ColBERT are disclosed in, for example, Gao et al., “COIL: revisit exact lexical match in information retrieval with contextualized inverted list”, in Proc. NAACL-HLT, pages 3030-3042, 2021; Hofststter et al., “Introducing neural bag of whole-words with colberter: Contextualized late interactions using enhanced reduction”, in Proceedings of the 31st ACM International Conference on Information & Knowledge Management, pages 737-747, New York, NY, USA, 2022; Lee et al., “Rethinking the role of token retrieval in multivector retrieval”, 2023; Lin et al., “Fine-grained late-interaction multi-modal retrieval for retrieval augmented visual question answering”, in Thirty-seventh Conference on Neural Information Processing Systems, 2023; Qian et al., “Multi-vector retrieval as sparse alignment”, 2022; Santhanam et al., “Colbertv2: Effective and efficient retrieval via lightweight late interaction”, arXiv preprint arXiv:2112.01488, 2021; Wang et al., “Pseudo-relevance feedback for multiple representation dense retrieval”, in Proceedings of the 2021 ACM SIGIR International Conference on Theory of Information Retrieval, pages 297-306, New York, NY, USA, 2021; and Yao et al., “FILIP: Fine-grained interactive language-image pre-training”, in International Conference on Learning Representations, 2022.

ColBERTv2, for instance, refines the original ColBERT engine by introducing residual compression to reduce the space footprint of late interaction approaches. However, search speed remains a bottleneck, primarily due to the large number of candidates to re-rank exactly (>10 k). Avoiding the need to re-rank a large number of candidates via such exact late-interaction scoring, without materially degrading ranking quality, can therefore provide a concrete technical improvement in end-to-end retrieval latency and resource usage.

Late-interaction retrieval approaches such as ColBERT and its variants provide many useful properties, ranging from interpretability to robustness. For instance, a fine-grained interaction mechanism, based on a token-level dense vector representation of documents and queries, alleviates the inherent limitation of single-vector models such as DPR (e.g., Karpukhin et al., “Dense passage retrieval for open-domain question answering”, in Proceedings of the 2020 Conference on Empirical Methods in Natural Language Processing (EMNLP), pages 6769-6781, 2020). However, due to its MaxSim (i.e., summation of Maximum Similarity) formulation, late interaction retrieval has required a dedicated multi-step search pipeline. Reducing the complexity and computing requirements of such dedicated, multi-step pipelines can also reduce engineering complexity and implementation constraints (e.g., specialized components or hardware assumptions), which, among other benefits, can improve portability across different deployment environments.

An alternative approach is Learned Sparse Retrieval, e.g., as disclosed in Nguyen et al., “A unified framework for learned sparse retrieval”, in European Conference on Information Retrieval, pages 101-116, Springer, 2023. This approach is intended to reconcile the traditional search infrastructure with PLMs. However, for many applications it remains desirable to preserve, for downstream ranking, the fine-grained token-level interaction signals available from late-interaction models.

Another approach is PLAID, e.g., as disclosed in Santhanam et al., “Plaid: An efficient engine for late interaction retrieval”, in Proceedings of the 31st ACM International Conference on Information & Knowledge Management, pages 1747-1756, New York, NY, USA, 2022. PLAID provides an optimized late interaction pipeline based on ColBERT that addresses significant bottlenecks in terms of search speed in a basic ColBERTv2 pipeline, largely reducing the number of candidate passages without impacting ColBERTv2's effectiveness. PLAID candidate generation is based on three steps that leverage centroid interaction and centroid pruning—emulating traditional Bag-of-Words (BoW) retrieval—as well as dedicated CUDA kernels. PLAID reduces the large number of candidate documents to re-rank, greatly offloading subsequent steps including index lookup, decompression, and scoring. While effective, reliance on centroid-based heuristics and/or specialized kernels can complicate integration into conventional search stacks and can limit efficient execution in commodity CPU environments.

Yet another useful approach for learned sparse retrieval includes so-called sparse lexical and expansion, or SPLADE, models, for providing sparse representations (sparse vector representations or sparse lexical expansions; that is, where a subset of parameters may represent a larger set of parameters; e.g., where a subset of parameters are the only non-zero parameters that form part of a larger set of parameters of a model represented using a high-dimensional vector space; a sparse matrix is a matrix in which most elements are zero) in the context of IR by predicting a term importance of the input sequence over a vocabulary. An example sparse approach determines a prediction of an importance (or weight) for an input sequence over a vocabulary with respect to tokens of the input sequence. A sparse representation of predicted importance of the input sequence over the vocabulary can then be obtained by performing an activation that includes a concave function to prevent some terms from dominating. Systems and methods using a SPLADE approach can provide, among other things, expansion-aware representations of documents and queries. Because such representations are expressed in a vocabulary space, they are naturally compatible with inverted-index retrieval and can support explicit lexical matching and learned expansion within established query evaluation frameworks.

SPLADE models exhibit strong in-domain and zero-shot capabilities at a fraction of the cost of late interaction approaches, both in terms of memory footprint and search latency. While late-interaction approaches require multi-step retrieval engines to efficiently retrieve from large collections, namely approximate candidate generation followed by an exact reranking step, learned sparse retrieval models, such as SPLADE, can offer highly useful efficiency-effectiveness trade-offs.

Example SPLADE models are disclosed in U.S. patent application Ser. No. 17/804,983, filed Jun. 1, 2022, published as U.S. Patent Pub. No. 2023/0214633 on Jul. 6, 2023, U.S. patent application Ser. No. 18/312,703, filed May 5, 2023, published as U.S. Patent Pub. No. 2023/0418848 on Dec. 8, 2023, and U.S. patent application Ser. No. 18/417,335, filed Jan. 19, 2024. Other example SPLADE models are disclosed in Formal et al., “Splade v2: Sparse lexical and expansion model for information retrieval”, 2021; Formal et al., “SPLADE: Sparse Lexical and Expansion Model for First Stage Ranking”, in Proc. SIGIR, pages 2288-2292, 2021; and Formal et al., “From distillation to hard negative sampling: Making sparse neural ir models more effective”, in Proceedings of the 45th International ACM SIGIR Conference on Research and Development in Information Retrieval, pages 2353-2359, 2022. Nonetheless, combining sparse candidate generation with late-interaction reranking can otherwise entail separate encoders and/or repeated PLM inference at query time, which can erode the efficiency gains sought in multi-stage retrieval.

Other disclosed methods provide hybrid models that exploit similarities between the representations learned by different neural ranking models. For instance, UNIFIER, as disclosed in Shen et al, Unifier: A unified retriever for large-scale retrieval, 2023, jointly learns dense and sparse single-vector bi-encoders by sharing intermediate transformer layers. Similarly, the BGE-M3 embedding model disclosed in Chen et al., “Bge m3-embedding: Multi-lingual, multi-functionality, multi-granularity text embeddings through self-knowledge distillation”, 2024, can perform dense, multi-vector, and sparse retrieval indifferently. Such hybridization may increase training and operational complexity, reduce retrieval effectiveness, and/or reduce the ability to efficiently adapt an already-deployed late-interaction backbone without retraining substantial portions of the model.

SparseEmbed, as disclosed in Kong et al., “Sparseembed: Learning sparse lexical representations with contextual embeddings for retrieval”, in Proceedings of the 46th International ACM SIGIR Conference on Research and Development in Information Retrieval (SIGIR '23), 2023, extends the SPLADE approach with dense contextual embeddings, based on concepts from ColBERT and from COIL (Gao et al., COIL: revisit exact lexical match in information retrieval with contextualized inverted list. In Proc. NAACL-HLT, pages 3030-3042, 2021). SLIM (Li et al., “SLIM: Sparsified late interaction for multivector retrieval with inverted indexes”, in Proceedings of the 46th International ACM SIGIR Conference on Research and Development in Information Retrieval, ACM, 2023) adapts ColBERT to perform late interaction on top of SPLADE-like representations, making it fully compatible with traditional search techniques. Ram et al., “What are you token about?dense retrieval as distributions over the vocabulary”, in Proceedings of the 61st Annual Meeting of the Association for Computational Linguistics (Volume 1: Long Papers), pages 2481-2498, Toronto, Canada, 2023, Association for Computational Linguistics, discloses that mapping representations of a dense bi-encoder to the vocabulary space via the Masked Language Model (MLM) head can also be used for interpretation purposes. However, there remains a technical need for an architecture that enables efficient sparse candidate generation using established inverted-index infrastructure while reusing the same PLM-produced token embeddings for subsequent late-interaction reranking, thereby avoiding duplicate transformer passes.

Example methods and systems provided herein can bridge the gap between late interaction retrieval and sparse information retrieval by configuring the candidate generation step in late interaction retrieval engines as a sparse retrieval task, providing benefits of both approaches. In particular, various embodiments of the present disclosure can replace heuristic or centroid-based approximate scoring with approximate scoring using a learned sparse mapping that is better aligned with late-interaction reranking, while leveraging inverted-index query evaluation to reduce candidate generation latency and computational overhead. This can be accomplished by mapping dense embeddings into sparse vectors using methods based on sparse retrieval models, such as by using a trained lightweight sparse encoder to adapt a dense backbone pretrained language model (PLM).

In example methods, the sparse encoder can include a lightweight adapter module (e.g., a masked language model (MLM) adapter) that may be configured to keep an original dense backbone PLM, such as ColBERT or ColBERTv2, frozen (e.g., keep the original weights frozen) during training so that a retrieval algorithm is adapted to an already-trained model. Training only the lightweight module while keeping the dense backbone frozen can reduce training time and memory, can mitigate disruption of backbone representations used for reranking, and can facilitate rapid adaptation of an existing late-interaction retriever/reranker to sparse candidate generation. However, in other example methods, the two models (multi-vector dense, sparse representation) may be jointly trained together, and the steps of candidate generation and reranking could thus be performed based on those representations. This may also remove overhead added by an MLM adapter. Joint training, where employed, can further improve alignment between sparse candidate generation and reranking representations and can reduce or eliminate runtime overhead associated with separate adaptation stages.

By adapting late interaction PLM representations, e.g., frozen representations, with a module for sparse retrieval, e.g., a light SPLADE module, example methods and systems can effectively map queries and documents in a sparse vocabulary space. Operating in the vocabulary space can increase interpretability (e.g., by exposing weighted lexical terms and expansions) and can enable use of efficient sparse retrieval pruning and top-k selection mechanisms. Methods and systems herein, illustrative examples of which are referred to herein as sparse late interaction models or SPLATE models, provide a novel approximate scoring method for late interaction pipelines. Such sparse approximate scoring can reduce the number of documents forwarded for exact late-interaction scoring (e.g., MaxSim), thereby improving end-to-end latency for a given effectiveness target.

An example training method learns an MLM adapter module, mapping its frozen token embeddings to a sparse vocabulary space with a partially learned sparse encoding module, such as may be provided by SPLADE-based models. This allows example methods to perform candidate generation in late interaction pipelines with sparse retrieval techniques, including but not limited to conventional sparse retrieval techniques. Because the adapter is trained to map frozen token embeddings into a sparse space that approximates the late-interaction teacher's behavior, candidate generation can be better aligned with the reranking stage, improving end-to-end effectiveness for a fixed candidate set size and latency budget. This can be particularly useful, for instance, for running dense backbone PLMs such as ColBERT or variants thereof in lower processing power (e.g., mono-CPU) environments.

Existing late-interaction engines (e.g., ColBERTv2, PLAID, CITADEL, EMVB, WARP) rely on well-designed heuristics to perform candidate generation. On the other hand, in example methods and systems herein, a candidate generation step can be learned and performed in a sparse lexical space. This allows candidate generation to benefit from highly optimized query processing algorithms for sparse information retrieval. It can also allow such candidate generation methods to be more interpretable for further analysis or optimization. Further, sparsity and/or representation size can be configured (e.g., via pooling and/or pruning) to provide a controllable effectiveness—efficiency tradeoff, including controlling index size, query-time computation, and latency.

In experiments, an example SPLATE pipeline adapting ColBERTv2 achieved the same effectiveness as a prior ColBERTv2 engine, PLAID, in reranking a set of 50 documents that could be retrieved in under 10 ms. This illustrates that, in illustrative implementations, candidate generation can meet strict latency targets while enabling exact reranking over a substantially reduced candidate set, thereby reducing compute and memory bandwidth consumption in the overall pipeline.

Example methods and systems herein can provide a competitive alternative retrieval approach for use in any application relying on multi-vector retrieval, such as but not limited to search systems and retrieval-augmented generation (RAG) systems. For example, in retrieval-augmented generation workflows, faster and more infrastructure-compatible candidate generation can reduce end-to-end response latency and/or enable more frequent retrieval updates under fixed compute budgets.

### Sparse Encoding Method for Adapting Dense PLM

Generally, an example information retrieval approach can exploit the recognition that a late interaction pipeline can be optimized using techniques from BoW retrieval, and that dense embeddings can be mapped to the vocabulary space. Example methods can adapt context representations generated from dense PLM backbone models by encoding sparse representations of PLM-embedded inputs. In some embodiments, encoding the input sequence into a sparse representation in a vocabulary space enables candidate generation to be executed using a sparse index structure stored in memory (e.g., an inverted index), thereby reducing index storage requirements and reducing processor utilization and/or latency relative to candidate generation based on dense multi-vector representations or approximate nearest-neighbor search.

With such an approach, example methods can approximate a candidate generation step in late interaction retrieval by exploiting similarities between the representations learned by sparse and dense IR models. Example methods can also be based on the recognition that effective sparse models can be derived, or at least adapted, from frozen embeddings of dense IR models. The resulting sparse embeddings can be useful for indexing and retrieval, e.g., as meaningful BoW. Some example systems accordingly branch an MLM head over a frozen dense PLM backbone model. In some embodiments, the same embedded context representations produced by the dense PLM for an input query (and, for documents, precomputed embedded context representations) are reused both (i) to derive the sparse representation used for candidate retrieval and (ii) to support a late-interaction reranking computation, so that end-to-end retrieve-and-rerank operation can be achieved without requiring an additional transformer inference pass for the query beyond the one used to obtain the embedded context representations. This reuse can reduce inference-time compute, memory bandwidth, and/or energy consumption while preserving effectiveness.

Example methods and systems may incorporate features of adapters. Example adapters include Houlsby Adapters, e.g., as disclosed in Houlsby et al., Parameter-efficient transfer learning for nlp, Chaudhuri, K., Salakhutdinov, R. (eds.) ICML, Proceedings of Machine Learning Research, vol. 97, pp. 2790-2799. PMLR (2019). Other example adapter modules include Pfeiffer Adapters, e.g., as disclosed in Pfeiffer et al., Mad-x: An adapter-based framework for multi-task cross-lingual transfer. In: EMNLP (2020). Houlsby and Pfeiffer Adapters can be employed, for instance, by inserting small bottle-neck layers over the frozen PLM backbone model to provide an adapter-based head, and optimizing the adapter-based head for natural language processing (NLP) tasks. Houlsby Adapters and Pfeiffer Adapters have previously demonstrated comparable effectiveness to fine-tuning on various NLP tasks. In some embodiments, such adapter-based heads are configured to be lightweight and trained while keeping the dense PLM frozen, which can reduce training-time computation and memory footprint and can enable deployment and/or adaptation in resource-constrained environments (e.g., CPU-only environments) while maintaining a shared backbone representation for both sparse candidate generation and late-interaction reranking.

### Information Retrieval System

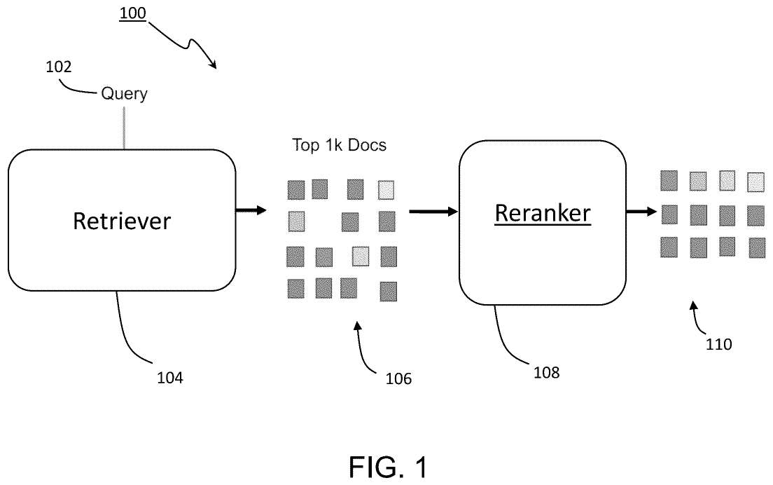

Referring now to the drawings, FIG. 1 shows an example system 100 using a neural model for information retrieval (IR) of documents, such as but not limited to a search engine or a retrieval-augmented generation (RAG) system, which may be configured, trained, and operated using training methods as provided herein. A query 102 is input to a first-stage retriever (candidate generation) 104. Example queries include but are not limited to search requests or search terms for providing one or more documents (of any format), questions to be answered, items to be identified, etc. The first-stage retriever 104 processes the query 102 to provide a ranking of available documents, e.g., from a corpus of documents, and retrieves a first set 106 of top-ranked candidate documents. A second-stage or reranker 108 then reranks the retrieved set 106 of top-ranked documents and outputs a ranked set 110 of documents, which may be fewer in number than the first set 106.

Example neural ranker models may provide representations, e.g., vector representations, of an input sequence over a vocabulary. The input sequence can be embodied in, for instance, a query sequence such as the query 102 (that may be received by an input device audibly, using for example, a microphone, or physically, using for example, a keyboard, mouse, touch screen, or from a downstream application, such as, a voice or virtual assistant), a document sequence to be ranked and/or retrieved based on a query, or any other input sequence. “Document” as used herein broadly refers to any sequence of tokens that can be represented in vector space and ranked using example methods and/or can be retrieved. A query broadly refers to any sequence of tokens that can be represented in vector space for use in ranking and retrieving one or more documents.

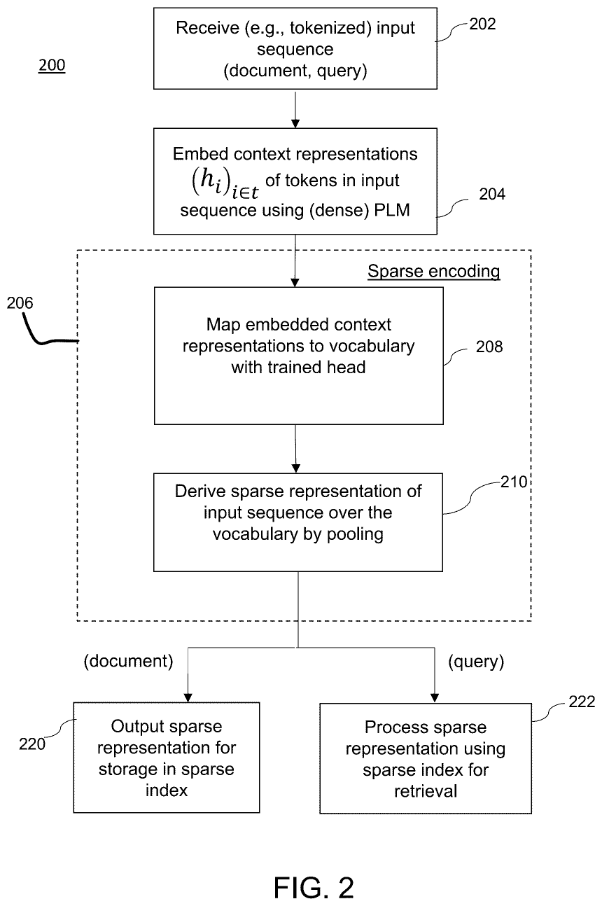

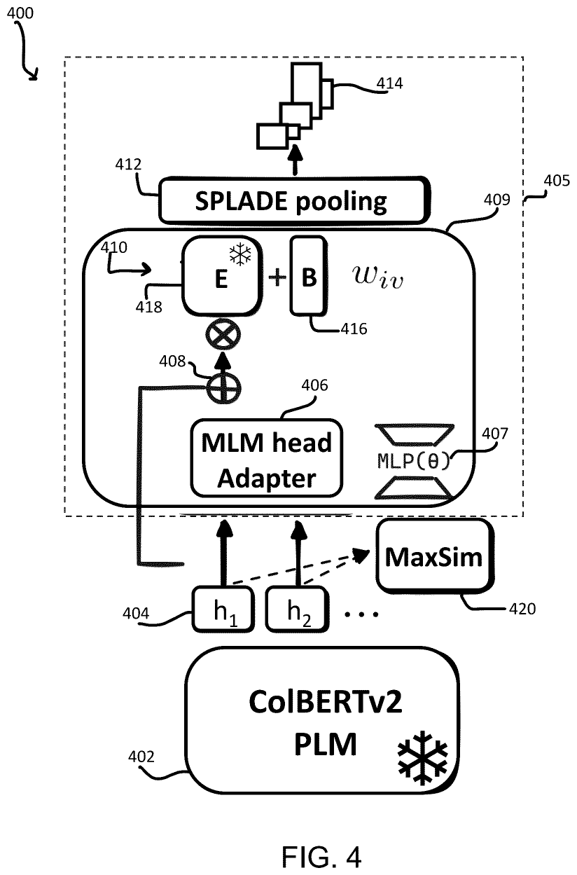

FIG. 2 shows an example input sequence (i.e., document or query) encoding method 200, and FIG. 4 shows an example encoding system 400 for encoding an input sequence including a dense pretrained language model (PLM) backbone, e.g., ColBERTv2 402. An example PLM backbone 402 can be based on an attention-based architecture, e.g., a transformer architecture, such as but not limited to architectures disclosed in U.S. Pat. No. 10,452,978, issued Oct. 22, 2019, which is incorporated by reference herein. The system 400 can be implemented by one or more computers having at least one processor and one memory. For instance, the system 400 may be implemented using one or more CPU cores, alone or in combination with one or more GPUs, along with a suitable memory.

The example encoding method 200 encodes the input sequence by providing a representation of the input sequence over a vocabulary. A nonlimiting example vocabulary that may be used is BERT WordPiece vocabulary (e.g., [V]=30522), which representation may be used for ranking and/or reranking in IR. BERT-based models may be pre-trained on tasks including masked-token prediction, referred to as a “masked language model (MLM) task,” and next-sentence prediction. These example models are bidirectional in that each token attends to both its left and right neighbors, not only to its predecessors.

An input sequence is received by the system at 202. The input sequence may be tokenized by a tokenizer layer using the vocabulary (for example, a predetermined BERT vocabulary) to provide a tokenized input sequence t₁ . . . t_{N}, or may be otherwise provided. The input sequence may also include one or more special tokens, such as but not limited to <CLS> (a symbol added in front of an input sequence, which may be used in some BERT methods for classification) and/or <SEP> (used in some BERT methods for a separator), as can be used in BERT embeddings.

Tokens in the input sequence are embedded at 204 by the dense PLM 402 to provide a sequence of embedded tokens 404 h₁ . . . h_{N}. This embedding may be a dense context embedding based on, for instance, the vocabulary and the token's position within the input sequence. The embedded (e.g., context embedded) tokens h₁ . . . h_{N} may represent contextual features of the tokens within the embedded input sequence. An example embedding may use one or more embedding layers of the dense PLM, e.g., one or more attention-based (such as transformer-based) layers. For reranking methods, this embedding may be forwarded, e.g., to a MaxSim module 420 (i.e., summation of Maximum Similarity), which may be used to represent a document encoding that has highest similarity with a query encoding.

A sparse encoding module 405 performs a sparse encoding at 206 to provide a sparse representation of the input sequence over the vocabulary. To perform sparse encoding, the sparse encoding module 405 includes an adapter 406, e.g., a masked language model (MLM) head adapter 406 incorporating a multilayer perceptron (MLP) 407, and a residual connection 408 (which may be considered either part of or separate to the adapter 406) that each receive the embedded tokens 404 from the dense PLM 402, as well as a logit layer 410 for determining an importance, weight, or representation of each token in the vocabulary with respect to each token of the input sequence (e.g., a token-level or local representation in the vocabulary space). The MLP 407 of adapter 406, the residual connection 408, and the logit layer 410 together can provide a trained head 409 that can be coupled to or otherwise integrated with the dense PLM 402. The sparse encoding module 405 further includes a pooling layer 412 that predicts a sparse representation 414 of term importance of the input sequence as a representation of importance (weight) of the input sequence over the vocabulary.

In an example sparse encoding 206, embedded context representations, e.g., context embedded tokens 404, are mapped to the vocabulary at 208 using the trained head 409 (e.g., the adapter 406, residual connection 408, and logit layer 410). Then, the pooling layer 412 derives a sparse representation of the input sequence over the vocabulary by pooling at 210.

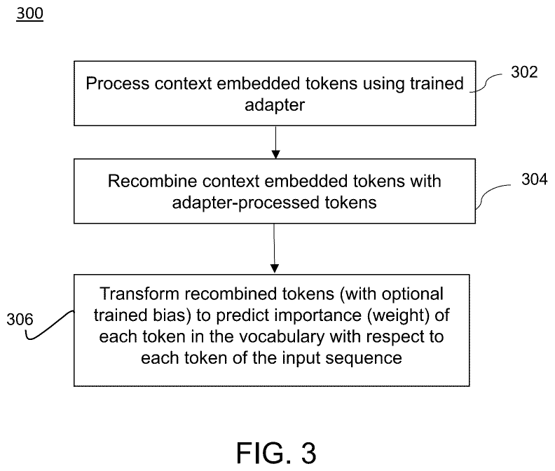

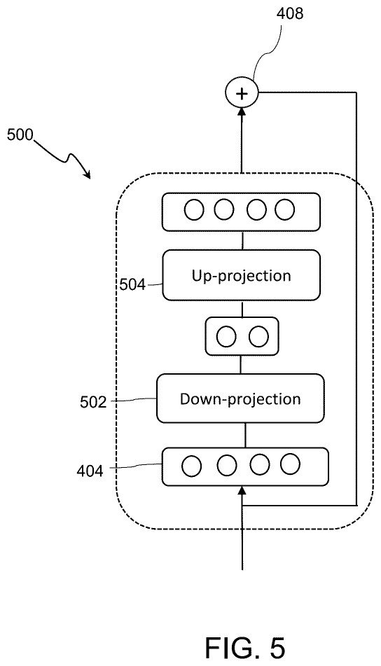

FIG. 3 shows an example method 300 for mapping context embedded tokens 404 to the vocabulary (step 208). The trained adapter 406 processes the context embedded tokens 404, e.g., via trained down-projection 502 and up-projection layers 504 as shown in the example adapter 500 (an example of adapter 406) in FIG. 5. The context embedded tokens are combined, e.g., at residual connection 408, with the adapter-processed (e.g., down-projected and up-projected, bottlenecked, etc.) tokens. The recombined tokens are transformed, with optional trained bias 416, to predict importance, or weight, of each token in the vocabulary with respect to each token of the input sequence at 306.

If the received input sequence is a document, e.g., a document to be indexed, the sparse representation of the document can be indexed for storage at 220. This process may be performed offline or online. On the other hand, if the received input sequence is a query, the sparse representation of the query can be processed, e.g., using a sparse index for retrieval at 222.

### Model Definition

An example model for information retrieval will now be explained with respect to an illustrative frozen dense PLM backbone model, ColBERT, and more particularly ColBERTv2 402. Given ColBERT's contextual embeddings (hᵢ)_{i∈t} of an input query or document t, a simple masked language model (MLM) head (generally, a head trained with self-supervised learning for learning relationships and context by predicting masked words of a dataset), which can be referred to as a trained head or trained MLM head, may be defined by linearly mapping transformed representations back to the vocabulary. Using an approach analogous to adapter modules, e.g., as disclosed in Houlsby et al. and in Pfeiffer et al., an example model adapts frozen representations (hᵢ)_{i∈t} (that is, representations by a frozen PLM) such as context embeddings 404 by adapting the trained head, e.g., by learning a (for instance) two-layer multilayer perceptron (MLP) 407, e.g., of adapter 406, 500, whose output is recombined in a residual fashion, e.g., at residual connection 408, before (e.g., MLM) vocabulary projection (e.g., at logit layer 410):

wᵢᵥ=(hᵢ+MLP_{θ}(hᵢ))^{T}Eᵥ+bᵥ (1)

where wᵢ corresponds to an unnormalized log-probability distribution over a vocabulary V for the token tᵢ, hᵢ is a contextual embedding vector for token i generated by the dense PLM, MLPe is a trainable multilayer perceptron (e.g., a two-layer adapter) parameterized by θ, Eᵥ is the dense PLM (e.g., ColBERT) input embedding 418 for the token v, and bᵥ is a token-level bias 416 that can be learned. The residual provides a near-identity initialization, allowing training to be more stable. In a non-limiting example implementation, the MLP comprises a down-projection layer that reduces an embedding dimension of 768 to a latent dimension of 384 followed by an up-projection layer returning to 768, resulting in on the order of ~0.6 M trainable parameters for the trained head, while keeping the dense PLM backbone and (optionally tied) projection layer E frozen, as indicated by the snowflake symbols in FIG. 4.

Sparse vectors over the vocabulary, e.g., SPLADE vectors, can then be derived from these logits 410, e.g., by the pooling layer 412, as follows to yield a IVI-dimensional sparse vector whose non-zero entries represent term importance over the vocabulary:

$${w}_{v} = {max}_{i ∈ t} log ( 1 + ReLU ( {w}_{iv} ) ) , v ∈ \{ 1 , … , \vert V \vert \} \qquad ( 2 )$$

In some embodiments, sparsity is explicitly controlled by retaining only the top-k highest-weighted vocabulary terms after pooling and setting remaining entries to zero. In one example, the system retains top-kq terms for query sparse vectors and top-kd terms for document sparse vectors (top-k_{q,d} pooling), where kq and kd may be selected to balance retrieval latency, memory footprint, and effectiveness. Sparsity control may be used to further configure latency and/or memory usage.

At pretraining, the dense PLM 402 and the MLM head (e.g., including logit layer 410) may be trained on a Masked Language Model task. During fine-tuning of the encoding system 400, the MLP 407 of the adapter 406, 500 and the bias 416 of the logit layer 410 may be trained while the PLM 402 remains frozen. For instance, an example training method can train the parameters of the adapted head (θ, b), e.g., the parameters of the adapter 406, 500 and the bias 416, with distillation based on the derived SPLADE vectors to reproduce the dense PLM models scores. An example approach can be very light, as the PLM backbone model can be entirely frozen, including the (tied) projection layer E 418.

In an example default setting, the MLP 407 in the adapter 406, 500 first down-projects representations, e.g., representations 404, by a factor of two (for instance) at down-projection layer 502, then up-projects back to the original dimension, e.g., at up-projection layer 504. As a nonlimiting example, the MLP 407 can correspond to a latent dimension of 768/2=384, amounting to approximately 0.6 M trainable parameters, e.g., for the adapter 406 and the bias 416 in FIG. 4. The choice of these hyperparameters, however, can vary.

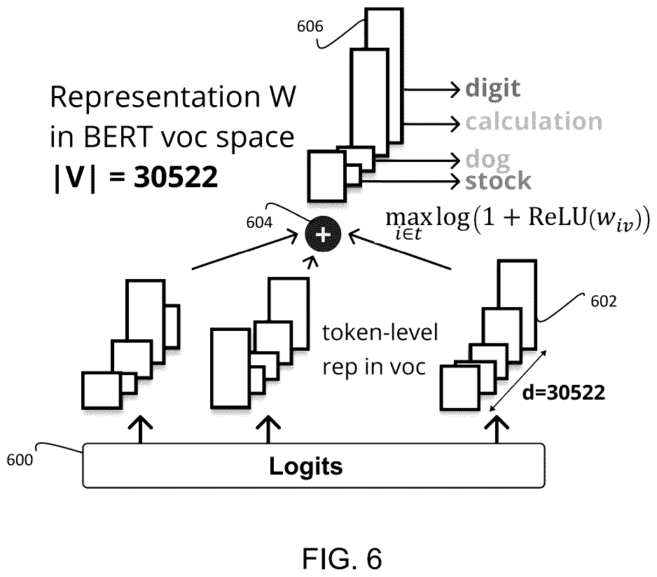

FIG. 6 shows an example pooling method, such as may be performed by pooling layer 412. Logits 600, e.g., from logit layer 410 provide a token-level representation 602 of each token in the input sequence across the vocabulary, which in this example has a size of 30522, though this number can be larger or smaller. A pooling function 604, such as provided by Equation (2), generates a representation wᵥ 606 for the input sequence in the vocabulary space.

Training may include but is not limited to training or tuning for tasks such as information retrieval, domain adaptation, generalization, transfer learning, or others. Initial parameters may additionally or alternatively be randomized or initialized (for example) in any suitable manner. The parameters of the trained head 409 may be trained (e.g., adapter 406 and bias 416 parameters may be updated) while other parameters, such as one or more, or all, parameters of the PLM, may be frozen as described above. However, it is also possible that some parameters of the PLM may also be updated during the fine-tuning process.

Distillation can be provided in combination with features of any of the example models or training methods. An example distillation-based training method may be based on or incorporate methods disclosed in Hofstatter et al., Improving Efficient Neural Ranking Models with Cross-Architecture Knowledge Distillation, arXiv:2010.02666, 2020.

In one embodiment, parameters of the trained head (e.g., adapter parameters θ and bias parameters b) are trained by distillation from a frozen late-interaction dense PLM scoring function. For example, for training triples comprising a query, a relevant document, and one or more non-relevant documents, teacher scores are computed using late-interaction scoring (e.g., MaxSim), and the trained head is optimized to match the teacher scores using a weighted combination of a margin mean squared error (marginMSE) loss and a Kullback-Leibler divergence (KLDiv) loss. In a further embodiment, hard negatives are selected for each query from a top-N candidate list produced by the teacher model (e.g., top-1000), and a predetermined number of negatives (e.g., 20) are used per query.

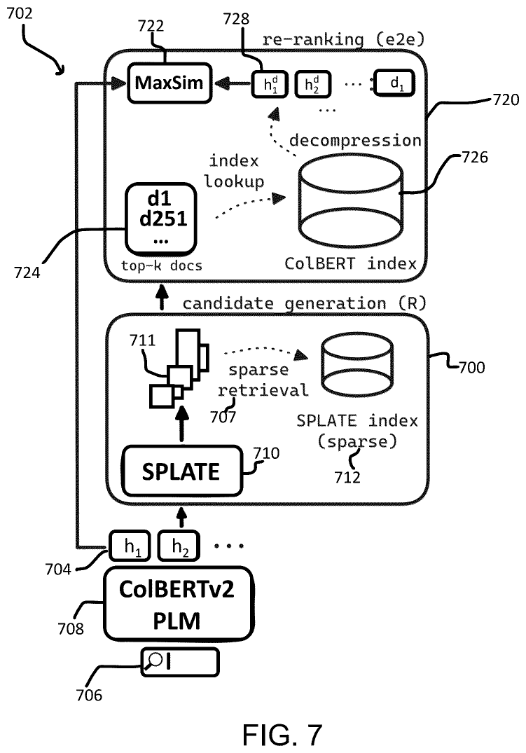

Efficient Candidate Generation for Late Interaction: By adapting a dense PLM backbone's (e.g., ColBERT 402) frozen dense representations 404 with a sparse encoding module 405, examples of which are referred to herein as SPLATE modules, the resulting system 400 can be incorporated in a retrieval module, such as retrieval (candidate generation) module 700 in FIG. 7. The retrieval module 700 can approximate late interaction scoring, e.g., with an efficient sparse dot product. The retrieval module 700 may operate and/or be evaluated as a standalone system for candidate generation, as indicated by (R) in experiments described below, or be incorporated into an information retrieval system 702, e.g., with a re-ranking module 720, as indicated by (e2e) in experiments described below.

As shown in FIG. 7, the same representations (hᵢ)_{i∈t} 704 of a document, e.g., of a query 706 generated by a dense PLM backbone 708, can also function for both stages of retrieval, e.g., via a SPLATE module 710 of retrieval module 700, and for re-ranking 720, e.g., via ColBERT's MaxSim (summation of Maximum Similarity) module 722. In some embodiments, MaxSim computes a similarity score between a query and a candidate document by, for each query token embedding, taking a maximum similarity over the candidate document's token embeddings and summing the resulting maxima across query tokens. For instance, MaxSim score(q, d) may be defined as:

$$Max Sim score ( q , d ) = {\sum }_{i} {max}_{j} ( {q}_{i} \cdot {d}_{j} )$$

In this way, an IR method provided by the IR system 702 need involve only a single transformer inference step on query and document sides. Accordingly, it becomes possible to replace an existing candidate generation step in late retrieval pipelines (such as with PLAID) with sparse retrieval to efficiently provide the dense PLM backbone, e.g., ColBERT, with documents to re-rank. Example methods and systems herein can therefore be implemented as an alternative pipeline by bridging the gap between sparse and dense models.

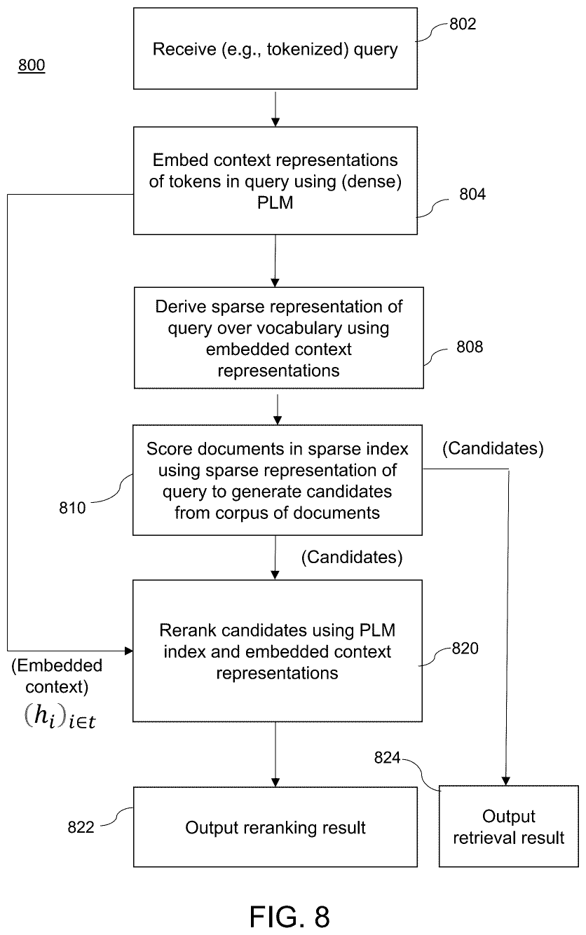

FIG. 8 shows an example inference, e.g., information retrieval, method 800 that may be performed by the information retrieval system 702 for late interaction retrieval from a corpus of documents. A document such as a query (e.g., tokenized) is received at 802, e.g., by the dense backbone PLM 708. The dense backbone PLM 708 embeds context representations of tokens in the query at 804, and the resulting embedded context 708 is passed to the retrieval module 700 for candidate generation, and optionally also to the re-ranking module 720.

The sparse embedding module, e.g., SPLATE module 710 of retrieval module 700, derives a sparse representation 711 of the query over the vocabulary using the embedded context representations 708 at 808. The retrieval module 700 then compares, e.g., via a comparator 707, the sparse representation 711 to a sparse index 712, e.g., that stores encoded sparse representations of documents in the corpus of documents, to score documents in the sparse index and generate candidates from the corpus of documents at 810. If the retrieval module 700 is operating as a standalone module (or being evaluated, for instance), the generated candidates may be output for storage on a storage device, display on a display device (such as a display), for transmission over an audible device (such as a speaker), and/or for downstream tasks at 824.

In an example comparison method performed by the comparator 707 that may be used for document scoring for candidate generation, a sparse representation of a query, generated by a document encoder provided by a dense PLM with a sparse encoder, is compared to sparse representations of each of a plurality of candidate sequences in the sparse index 712. The candidate sequences may be generated offline, online, or a combination of offline and online. The candidate sequences may be respectively associated with candidate documents (or themselves be candidate documents) from the corpus of documents for information retrieval. In example methods herein, the same encoder may be used to encode both documents and queries, e.g., providing a mono-encoder setup, though it is possible that a document-side encoder and query-side encoder could be separate encoders.

An example comparison may include, for instance, taking a dot product between the representations of documents and queries. This comparison may provide a ranking score. The plurality of candidate sequences associated with the representations can then be ranked, e.g., based on the determined ranking score, and a subset of the documents (e.g., the highest ranked set, a sampled set based on the ranking, etc.) can be retrieved.

In one embodiment, the sparse index 712 comprises an inverted index storing, for each vocabulary term, a posting list of document identifiers and associated sparse weights. During candidate generation, the comparator 707 evaluates the sparse query representation against posting lists for terms present in the sparse query representation and may apply query-processing optimizations that reduce memory accesses and arithmetic operations, including but not limited to MaxScore, WAND, and/or block-max WAND pruning based on score upper bounds.

If the reranking module 720 is employed, the generated candidates, e.g., top-k documents 724, are passed to the reranking module 720, and the context embedded query 704 is passed to the MaxSim module 722. The candidates 724 are reranked, e.g., by taking as input both query 704 embedded context and document 728 embedded contexts for the candidate documents (e.g., using index 726, which may be a dense index), and outputting a score. The reranking result may be output, displayed, stored, and/or used for downstream tasks at 822. In some embodiments, sparse document representations stored in the sparse index are generated offline by applying the trained head and pooling to document token embeddings already stored in a dense index for reranking, thereby deriving the sparse index from the dense index without additional transformer inference for those documents.

Features and Advantaqes: Compared to other approaches based on dense PLMs such as PLAID, an example approach herein can include one or more of the following features and/or advantages:
PLAID implicitly derives sparse BoW representations from ColBERTv2's centroid mapping, while methods herein can explicitly learn such representations by adapting a trained head such as a pseudo-MLM head to dense PLM (e.g., ColBERT) frozen representations. An approximation step can then become supervised rather than (yet efficiently) engineered.
Candidate generation for example methods can benefit from the longstanding efficiency of various inverted indexes and query processing techniques, such as but not limited to MaxScore, e.g., as disclosed in Turtle and Flood, Query evaluation: Strategies and optimizations. Inf. Process. Manage., 31 (6):831-850, 1995; or WAND, e.g., as disclosed in Broder et al., “Efficient query evaluation using a two-level retrieval process”, in Proceedings of the Twelfth International Conference on Information and Knowledge Management, pages 426-434, New York, NY, USA, 2003. Such benefits also make end-to-end operation of dense PLMs such as ColBERT more processor-friendly, as illustrated in experiments described below.
Example methods and systems can be more controllable and more directly amenable to various optimizations for learned sparse models, such as but not limited to those disclosed in Lassance and Clinchant, “An efficiency study for splade models”, in Proceedings of the 45^{th} International ACM SIGIR Conference on Research and Development in Information Retrieval, pages 2220-2226, New York, NY, USA, 2022; or Lassance et al., “A static pruning study on sparse neural retrievers”, in Proceedings of the 46^{th} International ACM SIGIR Conference on Research and Development in Information Retrieval, pages 1771-1775, New York, NY, USA, 2023.
The dense PLM backbone's pipeline can become even more interpretable, as example candidate generation methods herein can operate in the vocabulary space, rather than, for instance, representing documents as a lightweight bag of centroids.

Example systems may be trained with an additional, e.g., light, training round for the parameters of the sparse encoding adapter module. Example methods may also involve indexing the encoded sparse document vectors. While these can add a small memory footprint overhead, the added load is negligible compared to, say, ColBERT's index. Further, while hybrid approaches such as BGE-M3, as disclosed in Chen et al., Bge m3-embedding: Multi-lingual, multi-functionality, multi-granularity text embeddings through self-knowledge distillation, 2024, can output sparse and multi-vector representations and could conceivably be used in late interaction pipelines, example methods and systems herein can be particularly optimized to approximate a dense PLM such as but not limited to ColBERTv2.

### Experiments

An IR model according to example methods and systems herein, referred to as a SPLATE model, was initialized with a dense backbone PLM, ColBERTv2, as disclosed in Santhanam et al., Colbertv2: Effective and efficient retrieval via lightweight late interaction, arXiv preprint arXiv:2112.01488, 2021, in which weights, were kept frozen. Top-k_{q,d} pooling was used to obtain, respectively, query and document bag-of-words (BoW) sparse vector embedding (here, SPLADE) representations. While SPLADE may also be trained with sparse regularization in example systems and methods, top-k_{q,d} pooling can have comparable effectiveness while being simpler.

MLM parameters (θ, b) were trained on the MS MARCO passage dataset, as disclosed in Bajaj et al., Ms marco: A human generated machine reading comprehension dataset, In InCoCo@NIPS, 2016, using both distillation and hard negative sampling. In the experiments, ColBERTv2's scores were distilled based on a weighted combination of marginMSE (Hofststter et al., Improving efficient neural ranking models with cross-architecture knowledge distillation, 2021) and KL-Div (Lin et al., Fine-grained late-interaction multi-modal retrieval for retrieval augmented visual question answering, In Thirty-seventh Conference on Neural Information Processing Systems, 2023) losses for three epochs. A batch size was set to 24, and 20 hard negatives were selected per query, coming from ColBERTv2's top-1000. By using the same PLM (here, ColBERTv2) as both the teacher and the source of hard negatives, the example SPLATE model aimed to approximate late interaction with sparse retrieval.

The SPLATE models were trained with the SPLADE codebase on 2 Tesla V100 GPUs with 32 GB memory in less than two hours. The SPLATE models were evaluated as a standalone sparse retriever (3R), as well as in an end-to-end late interaction pipeline (e2e) where it provided the PLM backbone, ColBERTv2, with candidates to re-rank, as shown in FIG. 7. As SPLATE (e2e) can be embodied as an adaptation of ColBERTv2, in reference to the experiments SPLATE and SPLATE ColBERTv2 can be used interchangeably.

For the standalone sparse retriever 3?, the PISA engine, as disclosed in Mallia et al., “PISA: performant indexes and search for academia”, in Proceedings of the Open-Source IR Replicability Challenge co-located with 42nd International ACM SIGIR Conference on Research and Development in Information Retrieval, OSIRRC@SIGIR 2019, Paris, France, Jul. 25, 2019, pages 50-56, 2019, was used to conduct sparse retrieval with block-max WAND and provide latency measurements as the Mean Response Time (MRT); that is, as the average search latency measured on the MS MARCO dataset using one core of an INTEL™ XEON™ Gold 6338 CPU @2.00 GHz.

For the end-to-end (e2e) late interaction pipeline, on-the-fly reranking was performed with the ColBERT library. Naïve re-ranking with ColBERT is sub-optimal compared to pipelines that precompute document term embeddings. integration of example sparse encoders into ColBERT's pipelines can be substantially seamless, since it can be accomplished by modifying the candidate generation step.

Models were evaluated on the MS MARCO dev set and the TREC DL19 queries, as disclosed in Craswell et al., Overview of the trec 2019 deep learning track, In TREC 2019, 2019 (in-domain). Out-of-domain evaluations were provided on 13 readily available BEIR datasets, as disclosed in Thakur et al., BEIR: A heterogeneous benchmark for zero-shot evaluation of information retrieval models, In Thirty-fifth Conference on Neural Information Processing Systems Datasets and Benchmarks Track (Round 2), 2021, as well as on the test pooled Search dataset of the LoTTE benchmark, as disclosed in Santhanam et al., Colbertv2: Effective and efficient retrieval via lightweight late interaction, arXiv preprint arXiv:2112.01488, 2021. Evaluations considered effects of SPLATE vectors on latency and re-ranking performance, accuracy of SPLATE candidate generation, and overall performance for in-domain and out-of-domain scenarios.

Latency Results: Table 1, below, depicts in-domain results on MS MARCO, in both retrieval-only (R) and end-to-end (e2e) settings. The table shows Retrieval Latency (MRT) retrieval-only (R) and end-to-end (e2e, k=50) MRR@10 on MS MARCO dev. The results demonstrate that it is possible to adapt a frozen ColBERTv2 model to an effective SPLADE model using a lightweight residual adaptation of its token embeddings. Several SPLATE models were considered in the experiments that were trained with varying pooling sizes (k_{q},k_{d}), as those parameters controlled the size of the query and document representations. The standard effectiveness-efficiency trade-off for sparse embedding (e.g., SPLADE) was observed, where pooling affected both the performance and average latency.

TABLE 1

| | R | | e2e (k = 50) |
|---|---|---|---|
| (k_{q}, k_{d}) | MRT (ms) | MRR@10 | MRR@10 |
| (5, 30) | 2.9 | 34.5 | 39.5 |
| (5, 50) | 4.3 | 35.5 | 39.7 |
| (5, 100) | 7.4 | 35.6 | 39.8 |
| (10, 100) | 24.0 | 36.7 | 40.0 |
| (20, 200) | 106.0 | 37.4 | 40.0 |

The results indicate that it was easy to control the latency of the candidate generation step by selecting appropriate pooling sizes. However, after re-ranking with ColBERTv2, all of the example models performed comparably. This result is useful for efficiency, as it is thus possible to use very lightweight models to cheaply provide candidates (in experiments, as low as 2.9 ms Mean Response Time (MRT)), while still achieving performance on par with the original ColBERTv2, as shown in Table 2, below.

For comparison, the end-to-end latency disclosed for a disclosed modification of ColBERT, PLAID (see Santhanam et al., “Plaid: An efficient engine for late interaction retrieval”, in Proceedings of the 31st ACM International Conference on Information & Knowledge Management, pages 1747-1756, New York, NY, USA, 2022), using a single CPU core, less conservative setting with k=10, was around 186 ms on MS MARCO. Given that candidate generation can account for approximately two-thirds of a complete example pipeline, example SPLATE-based retrieval models can provide a useful adaptation for dense backbone PLMs such as ColBERT on, for instance, mono-CPU environments.

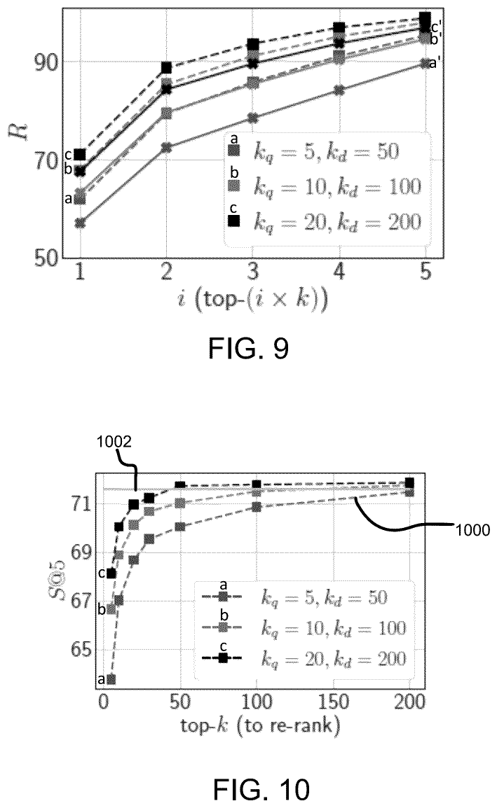

Approximation Quality: To assess the quality of SPLATE-based approximation for candidate generation, the top-k passages retrieved by PLAID ColBERTv2 (i.e., ColBERTv2 modified using PLAID) were compared to the ones retrieved by SPLATE (R). FIG. 9 shows candidate generation approximate accuracy on MS MARCO dev—SPLATE (R), where dotted lines (i.e., a, b, c) represent R(10), and solid lines (i.e., a′, b′, c′) represent R(100). The figure depicts the average fraction R(k) of documents in SPLATE's top-k′ that also appeared in the top-k documents retrieved by ColBERTv2 on MS MARCO, for k∈{10,100} and k′=i×k, i∈{1, . . . , 5}. When k=10, SPLATE could retrieve more than 90% of ColBERTv2's documents in its top-50 (i=5) for all levels of (k_{q},k_{d}). This illustrates the ability of SPLATE to fully recover ColBERT's performance by re-ranking a handful of documents (e.g., 50 only), though the quality of approximation diminished for efficient models (i.e., lower (k_{q}, k_{d})) when k was higher.

FIG. 10 illustrates performance of SPLATE (e2e) on out-of-domain experiments. Here, similar trends were observed, where increasing the number k of documents to re-rank and (k_{q}, k_{d}) led to better generalization. Overall, re-ranking only 50 documents provided a good tradeoff across all settings. However, the most efficient scenario ((k_{q},k_{d})=(5,50), k=10) still led to beneficial results: 38.4 MRR@10 on MS MARCO dev, 70.0 S@5 on LoTTE (line 1000 on FIG. 10).

Overall Results: Table 2, below, compares example SPLATE adaptations of ColBERTv2 with the reference points ColBERTv2 (Santhanam et al., Colbertv2: Effective and efficient retrieval via lightweight late interaction, arXiv preprint arXiv:2112.01488, 2021), and PLAID-based modification of ColBERTv2 (k=1000) (see Santhanam et al., “Plaid: An efficient engine for late interaction retrieval”, in Proceedings of the 31st ACM International Conference on Information & Knowledge Management, pages 1747-1756, New York, NY, USA, 2022), in both R and e2e settings. Results are also shown from SPLADE (see Formal et al., “From distillation to hard negative sampling: Making sparse neural ir models more effective”, in Proceedings of the 45th International ACM SIGIR Conference on Research and Development in Information Retrieval, pages 2353-2359, 2022) as well as the hybrid methods SparseEmbed (see Kong et al., “Sparseembed: Learning sparse lexical representations with contextual embeddings for retrieval” in Proceedings of the 46th International ACM SIGIR Conference on Research and Development in Information Retrieval (SIGIR '23), 2023) and SLIM++(see Li et al., “SLIM: Sparsified late interaction for multivector retrieval with inverted indexes”, in Proceedings of the 46th International ACM SIGIR Conference on Research and Development in Information Retrieval, ACM, 2023), even though these are not entirely comparable to example methods provided herein. While SparseEmbed and SLIM provide entirely new models, for instance, example SPLATE methods can be implemented as an adaptation to ColBERT's late retrieval pipeline.

Baselines were also provided including retrieving documents with BM25 and SPLADE++ and re-ranking those with ColBERTv2 (BM25>>C and S>>C respectively, with k=50). BM25 C relies on a less effective retriever, while S>>C is based on two different models, in that it requires feeding the query to a PLM twice at inference time. The experiments demonstrated that SPLATE (R) was effective as a standalone retriever (e.g., reaching almost 37 MRR@10 on MS MARCO dev). SPLATE e2e performed comparably to ColBERTv2 and PLAID on MS MARCO, BEIR, and LoTTE.

The table shows an evaluation of SPLATE with (k_{q},k_{d})=(10, 100) and k=50. In the table, abcde denote significant improvements over the corresponding rows, for a paired t-test with p-value=0.01 and Bonferroni correction (MS MARCO dev set and DL19). PLAID-modified ColBERTv2 (see Santhanam et al., “Plaid: An efficient engine for late interaction retrieval”, in Proceedings of the 31st ACM International Conference on Information & Knowledge Management, pages 1747-1756, New York, NY, USA, 2022) (k=1000) reports the dev LoTTE S@5.

TABLE 2

| | MS MARCO | DL19 | | BEIR | LoTTE |
|---|---|---|---|---|---|
| | MRR@10 | nDCG@10 | R@1k | nDCG@10 | s@5 |
| [symbol] Sparse/Hybrid | | | | | |
| SPLADE + + (9] | 38.0 | 73.2 | 87.5 | 50.7 | — |
| SparseEmbed [17] | 39.2 | — | — | 50.9 | — |
| SLIM + + (22] | 40.4 | 71.4 | 84.2 | 49.0 | — |
| [symbol] References | | | | | |
| ColBERTv2 [37] | 39.7 | — | — | 49.7 | 71.6 |
| (a) PLAID ColBERTv2 [38] | 39.8^{bd} | 74.6 | 85.2^{b} | — | 69.6* |
| (b) BM25 >> C (k = 50) | 34.3 | 68.7 | 73.9 | 49.0 | 62.8 |
| (c) 5 >> C (k = 50) | 40.4^{bd} | 74.4 | 87.5^{b} | 49.9 | 72.0 |
| [symbol] SPLATE ColBERTv2 (k = 50) | | | | | |
| (d) SPLATE (R) | 36.7^{b} | 72.9 | 84.4^{b} | 46.5 | 66.7 |
| (e) SPLATE (e2e) | 40.0^{bd} | 74.2 | 84.4^{b} | 49.6 | 71.0 |

A meta-analysis was also conducted against PLAID with RANGER (see Sertkan et al., “Ranger: A toolkit for effect-size based multi-task evaluation”, arXiv preprint arXiv:2305.15048, 2023) over the 13 BEIR datasets. No statistical differences were found on 10 datasets, and statistical improvement and loss were found in one and two datasets, respectively.

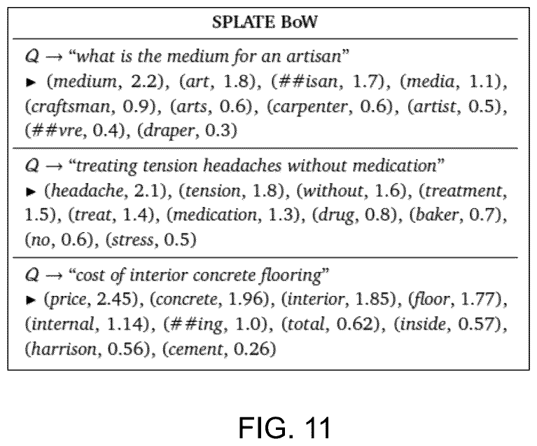

FIG. 11 illustrates examples of predicted BoW for three queries in MS MARCO dev. The results illustrate the interpretable nature of the retrieval step in an example SPLATE-adapted ColBERT pipeline.

In general, the experimental results demonstrated that an example SPLATE implementation of ColBERTv2 (SPLATE (e2e)) can bridge the gap with previous late interaction pipelines, by re-ranking a much lower number of documents. In contrast to the PLAID engine, for instance, the sparse term-based nature of an example candidate generation using SPLATE provides particular benefits for lower processing environments, e.g., mono-CPU environments in terms of efficiency.

Example lightweight candidate generation methods according to embodiments herein can simplify previous PLM-based methods for late interaction retrieval such as ColBERTv2. The PLM's frozen embeddings can be used, e.g., adapted, to conduct efficient sparse retrieval using sparse retrieval methods such as SPLADE. The experiments demonstrated that when evaluated end-to-end, an example SPLATE implementation of ColBERTv2 performed comparable to ColBERTv2 and PLAID on several benchmarks, by re-ranking a handful of documents.

### Network Architecture

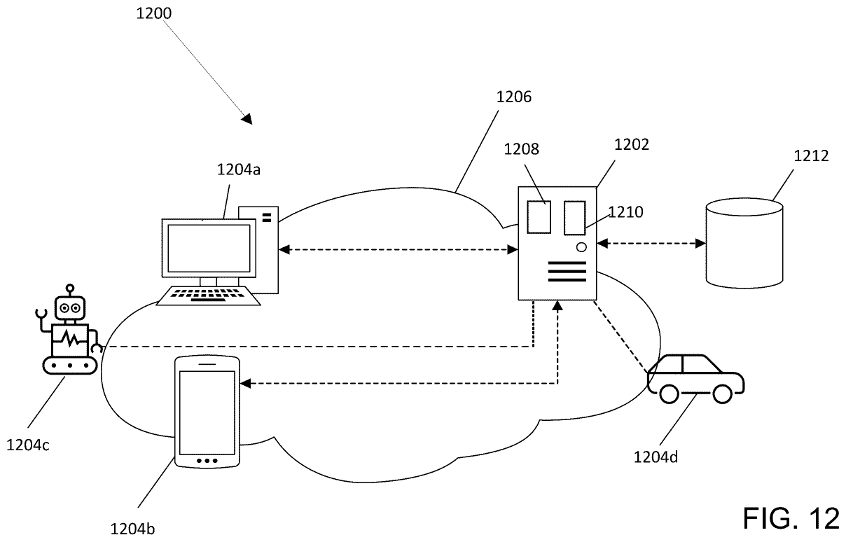

Example systems, methods, and embodiments may be implemented within a network architecture 1200 such as illustrated in FIG. 12, which comprises a server 1202 and one or more client devices 1204 that communicate over a network 1206 which may be wireless and/or wired, such as the Internet, for data exchange. FIG. 12's hardware is configured by processor-executable instructions to implement the encoding, candidate generation, sparse indexing, and reranking operations described herein (e.g., with respect to FIGS. 1-8). The server 1202 and the client devices 1204a, 1204b can each include a processor, e.g., processor 1208 and a memory, e.g., memory 1210 (shown by example in server 1202), such as but not limited to random-access memory (RAM), read-only memory (ROM), hard disks, solid state disks, or other non-volatile storage media. Memory 1210 may also be provided in whole or in part by external storage in communication with the processor 1208. The server 1202, for example, may be embodied in one or more computers. Reference herein to “computer” or “a computer” is intended to refer to one or more computers.

In some embodiments, the server 1202 and/or a client device 1204 constitutes a special-purpose computing system by virtue of the processor 1208 executing processor-executable instructions stored in memory 1210 and/or storage 1212. Such instructions, when executed, cause the computing system to implement one or more of: tokenizing input sequences; generating embedded context representations using a dense pretrained language model (PLM) backbone; applying a trained head (e.g., an adapter and/or bias layer) to generate sparse representations over a vocabulary; building, storing, and updating one or more indexes including a sparse index (e.g., an inverted index with posting lists) and/or a dense index of embedded token representations; scoring documents for candidate generation (e.g., using sparse dot products and top-k selection); and reranking candidate documents using late interaction scoring (e.g., MaxSim) based on embedded context representations, thereby producing ranked retrieval outputs.

The encoding system 400 and information retrieval system 702 or any one or more components thereof, for instance, may be embodied in the server 1202 and/or client devices 1204. It will be appreciated that the processor 1208 can include either a single processor or multiple processors operating in series or in parallel, and that the memory 1210 can include one or more memories, including combinations of memory types and/or locations. Server 1202 may also include, but are not limited to, dedicated servers, cloud-based servers, or a combination (e.g., shared). Storage, e.g., a database, may be embodied in suitable storage in the server 1202, client device 1204, a connected remote storage 1212 (shown in connection with the server 1202, but can likewise be connected to client devices), or any combination. As used herein, each ‘module’ (including, by way of example, an encoding system, sparse encoder, candidate generation module, comparator, reranking module, and/or indexing module) corresponds to structure comprising at least one processor and at least one memory storing processor-executable instructions (and/or dedicated circuitry such as an ASIC, FPGA, or GPU/accelerator circuitry) configured to perform the operations attributed to the module.

Client devices 1204 may be any processor-based device, terminal, etc., and/or may be embodied in a client application executable by a processor-based device, etc. Client devices may be disposed within the server 1202 and/or external to the server (local or remote, or any combination) and in communication with the server. Example client devices 1204 include, but are not limited to, autonomous computers 1204a, mobile communication devices (e.g., smartphones, tablet computers, etc.) 1204b, robots 1204c, autonomous vehicles 1204d, wearable devices, virtual reality, augmented reality, or mixed reality devices (not shown), or others. Client devices 1204 may be configured for sending data to and/or receiving data from the server 1202, and may include, but need not include, one or more output devices, such as but not limited to displays, printers, etc. for displaying or printing results of certain methods that are provided for display by the server. Client devices may include combinations of client devices.

In an example training method, the server 1202 or client devices 1204 may receive a dataset from any suitable source, e.g., from memory 1210 (as nonlimiting examples, internal storage, an internal database, etc.), from external (e.g., remote) storage 1212 connected locally or over the network 1206. One or more modules, such as the dense PLM backbone, may be pretrained and stored, and may be frozen during training of the sparse encoder. The example training method can generate a trained encoding, candidate generation, and/or information retrieval model, including updated parameters of one or more adapter layers and/or bias layers, that can be likewise stored in the server (e.g., memory 1210), client devices 1204, external storage 1212, or combination. In some example embodiments provided herein, training and/or inference (e.g., document indexing, candidate generation, and/or reranking) may be performed offline or online (e.g., at run time), in any combination. Results can be output (e.g., displayed, transmitted, provided for display, printed, etc.) and/or stored for retrieving and providing on request. Results of earlier online or offline document processing, e.g., SPLATE index 712, other index data structures, e.g., ColBERT index 726, or other useful data more generally can be stored in the server (e.g., memory 1210), client devices 1204, external storage 1212, or combination for retrieval and use in example methods. In some embodiments, the trained parameters and index data structures reduce run-time processor cycles and memory bandwidth used for candidate generation by enabling sparse inverted-index query evaluation prior to late-interaction reranking.

In an example document processing method the server 1202 or client devices 1204 may receive one or more documents, e.g., documents or queries, from any suitable source, e.g., by local or remote input from a suitable interface, from external storage 1212, or from another of the server or client devices connected locally or over the network 1206. Trained models such as the example encoding model, candidate generation model, reranking model, information retrieval model, or any portion thereof (e.g., the PLM, sparse encoder, and/or indexes), can be likewise stored in the server (e.g., memory 1210), client devices 1204, external storage 1212, or combination. In some example embodiments provided herein, training and/or inference may be performed offline or online (e.g., at run time), in any combination.

In an example retrieval (candidate generation and/or reranking) method the server 1202 or client devices 1204 may receive a query from any suitable source, e.g., by local or remote input from a suitable interface, or from another of the server or client devices connected locally or over the network 1206 and process the query using example neural models (and/or by a more straightforward tokenization, in some example methods). Results can be output (e.g., displayed, transmitted, provided for display, printed, etc.) and/or stored for retrieving and providing on request.

### Example Embodiments

Embodiments herein provide, among other things, a computer-implemented method of late interaction information retrieval from a corpus of documents, the method comprising: receiving embedded context representations of tokens of an input sequence, the embedded context representations being generated by a dense pretrained language model (PLM); encoding a sparse representation of the input sequence from the embedded context representations using a trained head coupled to the dense PLM; comparing the encoded sparse representation to a sparse index to generate candidate documents from the corpus of documents; and outputting the generated candidate documents to one or more of an audible device, a display device, a storage device, and a downstream task; wherein the sparse index stores encoded sparse representations of documents in the corpus of documents. In addition to any one or more of the above features in this paragraph, encoding a sparse representation may comprise: mapping the embedded context representations to a vocabulary using the trained head; and deriving a sparse representation of the input sequence over the vocabulary by pooling. In addition to any one or more of the above features in this paragraph, the trained head may be adapted with an adapter. In addition to any one or more of the above features in this paragraph, mapping the embedded context representations may comprise: processing the embedded context representations using a trained multilayer perceptron (MLP) of the adapter, the trained MLP comprising a down-projection layer and an up-projection layer; recombining, in a residual manner, the context embedded tokens with the processed embedded context representations; and transforming the recombined tokens to predict a weight of each token in the vocabulary for each token of the input sequence. In addition to any one or more of the above features in this paragraph, transforming may further comprise projecting the recombined tokens through a projection layer of the dense PLM to generate token-level logits over the vocabulary, and adding a trained bias to the token-level logits. In addition to any one or more of the above features in this paragraph, the MLP and the bias may be trained while the dense PLM and the projection layer are frozen. In addition to any one or more of the above features in this paragraph, the dense PLM and the projection layer may be trained on a masked language model (MLM) task. In addition to any one or more of the above features in this paragraph, the method may further comprise reranking the generated candidate documents, wherein reranking comprises: receiving the embedded context representations of tokens from the dense PLM; receiving document embedded contexts for the candidate documents using a dense index; and outputting a score based on similarity of the received embedded context representations of tokens and document embedded contexts. In addition to any one or more of the above features in this paragraph, the dense PLM may be configured to perform a single transformer inference step to produce embedded context representations used for both encoding the sparse representation and reranking the generated candidate documents. In addition to any one or more of the above features in this paragraph, the input sequence may be a query received by an input device audibly or physically. In addition to any one or more of the above features in this paragraph, the dense PLM may comprise a ColBERT model. In addition to any one or more of the above features in this paragraph, deriving the sparse representation of the input sequence over the vocabulary by pooling comprises, for each vocabulary term v, computing an aggregate weight wᵥ=maxᵢ log(1+ReLU(wᵢᵥ)), where wᵢᵥ is a token-level logit for token position i and vocabulary term v. In addition to any one or more of the above features in this paragraph, pooling may further comprise retaining only a top-k subset of vocabulary terms having highest aggregate weights and setting remaining weights to zero. In addition to any one or more of the above features in this paragraph, deriving the sparse representation of the input sequence over the vocabulary by pooling may comprise, for each vocabulary term v, computing an aggregate weight wᵥ by performing an activation that includes a concave function over a token-level logit wᵢᵥ for token position i and vocabulary term v, where the concave function prevents one or more terms from dominating. In addition to any one or more of the above features in this paragraph, comparing the encoded sparse representation to the sparse index may comprise scoring documents in the sparse index by calculating a dot product between the encoded sparse representation of the input sequence and the encoded sparse representations of documents stored in the sparse index. In addition to any one or more of the above features in this paragraph, generating (i) the sparse representation used for candidate generation and (ii) the embedded context representations used for MaxSim reranking may both be performed from outputs of a single forward pass of the dense pretrained language model on the input sequence. In addition to any one or more of the above features in this paragraph, mapping the embedded context representations to the vocabulary may comprise: (i) applying a multilayer perceptron (MLP) to each token embedding and recombining the MLP output with the token embedding via a residual connection; (ii) projecting the recombined representation to vocabulary space using a token embedding matrix of the dense pretrained language model and an associated bias; and (iii) generating the sparse representation by applying log(1+ReLU(⋅)) followed by a max pooling over tokens for each vocabulary term.

Additional embodiments provide, among other things, a method for training an encoder for encoding an input sequence for late interaction information retrieval, the method comprising: coupling a head to a dense pretrained language model (PLM) to provide the encoder, the head comprising an adapter, a logit layer, and a pooling layer; freezing the dense PLM; training the head on an information retrieval task to update parameters of the trained head; wherein said training comprises, for a dataset of input sequences: the dense PLM receiving the input sequence and embedding context representations of tokens of the input sequence; the head encoding a sparse representation of the input sequence from the embedded context representations; and updating parameters of the head to optimize the encoder to approximate the dense PLM. In addition to any one or more of the above features in this paragraph, training may update parameters of the adapter of the trained head. In addition to any one or more of the above features in this paragraph, training may update parameters of a multilayer perceptron (MLP) of the adapter, the MLP comprising a down-projection layer and an up-projection layer. In addition to any one or more of the above features in this paragraph, the trained head may be an adapted masked language model (MLM) head. In addition to any one or more of the above features in this paragraph, the training may further update parameters of a bias layer of the logit layer used for generating weights of tokens in a vocabulary with respect to tokens of input sequences. In addition to any one or more of the above features in this paragraph, the training may comprise distillation using the dense PLM as a teacher. In addition to any one or more of the above features in this paragraph, the training may comprises in-batch negative sampling, wherein hard negatives are generated by the dense PLM. In addition to any one or more of the above features in this paragraph, the distillation may comprise minimizing a loss that includes a margin mean squared error (marginMSE) term and a Kullback-Leibler divergence (KLDiv) term between scores produced by the trained head and scores produced by the dense PLM teacher. In addition to any one or more of the above features in this paragraph, generating hard negatives by the dense PLM may comprise selecting, for each query, 20 hard negatives from among the top 1000 candidate documents generated by the dense PLM.

Additional embodiments provide, among other things, a system for encoding an input sequence comprising: a dense backbone PLM trained to embed context representations of tokens of the input sequence; and a sparse encoder coupled to the PLM and trained to encode a sparse representation of the input sequence from the embedded context representations using a trained head; wherein said sparse encoder comprises: an adapter configured to receive and process the embedded context representations, the adapter comprising a trained MLP; a logit layer configured to receive the processed context representations and the embedded context representations and map the embedded context representations to a vocabulary; and a pooling layer configured to generate a sparse representation of the input sequence over the vocabulary from an output of the logit layer; wherein the sparse encoder is trained while coupled to said PLM and while said PLM is frozen. In addition to any one or more of the above features in this paragraph, the MLP may comprise a down-projection layer and an up-projection layer; and the MLP may be trained while the PLM is frozen. In addition to any one or more of the above features in this paragraph, the logit layer may comprise a projection layer of the dense PLM and a bias layer; wherein the MLP and the bias layer are trained while said PLM and the projection layer are frozen. In addition to any one or more of the above features in this paragraph, the dense PLM and the projection layer may be pretrained on a trained masked language model (MLM) task.

Additional embodiments provide, among other things, a candidate generation module for generating candidate documents from a corpus of documents, the candidate generation module comprising: a system for encoding an input sequence according to the preceding paragraph; a sparse index storing sparse representations of documents; a comparator for comparing the encoded input sequence to sparse representations of documents stored in the sparse index to generate candidate documents from the corpus of documents; and an output device providing the candidate documents by one or more of (a) audibly via at least one speaker and (b) visually via at least one display. In addition to any one or more of the above features in this paragraph, the sparse representations of documents in the sparse index may be previously generated using context embeddings generated by the dense PLM. In addition to any one or more of the above features in this paragraph, the encoded input sequence may be a query. In addition to any one or more of the above features in this paragraph, the comparator may score documents in the sparse index by calculating a dot product between the encoded input sequence and the sparse representations of the documents in the sparse index. In addition to any one or more of the above features in this paragraph, the sparse index may comprise an inverted index and the comparator is configured to evaluate the encoded input sequence using at least one of MaxScore and WAND query evaluation.

Additional embodiments provide, among other things, an end-to-end information retrieval system comprising: a candidate generation module according to the preceding paragraph; and a reranking module coupled to said candidate generation module; wherein said reranking module processes the generated candidate documents using the embedded context representations of the input sequence. In addition to any one or more of the above features in this paragraph, the reranking module may comprise: an index of dense vector representations of documents; and a MaxSim (Maximum Similarity) module that receives the embedded context representations from the dense PLM and reranks the candidates based on similarity of the embedded context representations and dense vector representations of the candidate documents determined using the index. In addition to any one or more of the above features in this paragraph, the dense PLM may be ColBERT or a variation thereof.

Generally, embodiments can be implemented as computer program products with a program code or computer-executable instructions, the program code or computer-executable instructions being operative for performing one of the methods when the computer program product runs on a computer. The program code or the computer-executable instructions may, for example, be stored on a computer-readable storage medium.

In an embodiment, a storage medium (or a data carrier, or a computer-readable medium) comprises, stored thereon, the computer program or the computer-executable instructions for performing one of the methods described herein when it is performed by a processor.

Embodiments described herein may be implemented in hardware or in software. The implementation can be performed using a non-transitory storage medium such as a computer-readable storage medium, for example a floppy disc, a DVD, a Blu-Ray, a CD, a ROM, a PROM, and EPROM, an EEPROM or a FLASH memory. Such computer-readable media can be any available media that can be accessed by a general-purpose or special-purpose computer system.

### General

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure.

Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure.

All documents cited herein are hereby incorporated by reference in their entirety, without an admission that any of these documents constitute prior art.

Spatial and functional relationships between features (e.g., between modules, circuit elements, semiconductor layers, etc.) may be described using various terms, such as “connected,” “engaged,” “coupled,” “adjacent,” “next to,” “on top of,” “above,” “below,” “disposed”, and similar terms. Unless explicitly described as being “direct,” when a relationship between first and second features is described in the disclosure herein, the relationship can be a direct relationship where no other intervening features are present between the first and second features, or can be an indirect relationship where one or more intervening features are present, either spatially or functionally, between the first and second features, where practicable. As used herein, the phrase “at least one of” A, B, and C or the phrase “at least one of” A, B, or C, should be construed to mean a logical (A OR B OR C), using a non-exclusive logical OR, and should not be construed to mean “at least one of A, at least one of B, and at least one of C.”

In the figures, the direction of an arrow, as indicated by an arrowhead, generally demonstrates an example flow of information, such as data or instructions, that is of interest to the illustration. A unidirectional arrow between features does not imply that no other information may be transmitted between features in the opposite direction.

Each module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module. Each module may be implemented using code. The term code, as used above, may include software, firmware, and/or microcode, and may refer to programs, routines, functions, classes, data structures, and/or objects.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general-purpose computer to execute one or more particular functions embodied in computer programs. The functional blocks, flowchart components, and other elements described above serve as software specifications, which may be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

1. A computer-implemented method of late interaction information retrieval from a corpus of documents, the method comprising:
receiving embedded context representations of tokens of an input sequence, the embedded context representations being generated by a dense pretrained language model (PLM);
encoding a sparse representation of the input sequence from the embedded context representations using a trained head coupled to the dense PLM;
comparing the encoded sparse representation to a sparse index to generate candidate documents from the corpus of documents; and
outputting the generated candidate documents to one or more of an audible device, a display device, a storage device, and a downstream task;
wherein the sparse index stores encoded sparse representations of documents in the corpus of documents.

2. The method of claim 1, wherein said encoding a sparse representation comprises:
mapping the embedded context representations to a vocabulary using the trained head; and
deriving a sparse representation of the input sequence over the vocabulary by pooling.

3. The method of claim 2, wherein mapping the embedded context representations to the vocabulary comprises: (i) applying a multilayer perceptron (MLP) to each token embedding and recombining the MLP output with the token embedding via a residual connection; (ii) projecting the recombined representation to vocabulary space using a token embedding matrix of the dense pretrained language model and an associated bias; and (iii) generating the sparse representation by applying log(1+ReLU(⋅)) followed by a max pooling over tokens for each vocabulary term.

4. The method of claim 2,
wherein the trained head is adapted with an adapter;
wherein said mapping the embedded context representations comprises:
processing the embedded context representations using a trained multilayer perceptron (MLP) of the adapter, the trained MLP comprising a down-projection layer and an up-projection layer;
recombining, in a residual manner, the context embedded tokens with the processed embedded context representations; and
transforming the recombined tokens to predict a weight of each token in the vocabulary for each token of the input sequence.

5. The method of claim 4, wherein said transforming further comprises projecting the recombined tokens through a projection layer of the dense PLM to generate token-level logits over the vocabulary, and adding a trained bias to the token-level logits.

6. The method of claim 5, wherein the trained MLP and the bias are trained while the dense PLM and the projection layer are frozen.

7. The method of claim 6, wherein the dense PLM and the projection layer are trained on a masked language model (MLM) task.

8. The method of claim 5, wherein deriving the sparse representation of the input sequence over the vocabulary by pooling comprises, for each vocabulary term v, computing an aggregate weight wᵥ=maxᵢ log(1+ReLU(wᵢᵥ)), where wᵢᵥ is a token-level logit for token position i and vocabulary term v.

9. The method of claim 8, wherein pooling further comprises retaining only a top-k subset of vocabulary terms having highest aggregate weights and setting remaining weights to zero.

10. The method of claim 5, wherein deriving the sparse representation of the input sequence over the vocabulary by pooling comprises, for each vocabulary term v, computing an aggregate weight wᵥ by performing an activation that includes a concave function over a token-level logit wᵢᵥ for token position i and vocabulary term v, where the concave function prevents one or more terms from dominating.

11. The method of claim 1, wherein generating (i) the sparse representation used for candidate generation and (ii) the embedded context representations used for MaxSim reranking are both performed from outputs of a single forward pass of the dense pretrained language model on the input sequence.

12. The method of claim 1, wherein comparing the encoded sparse representation to the sparse index comprises scoring documents in the sparse index by calculating a dot product between the encoded sparse representation of the input sequence and the encoded sparse representations of documents stored in the sparse index.

13. The method of claim 1, wherein the method further comprises:
reranking the generated candidate documents, wherein said reranking comprises:
receiving the embedded context representations of tokens from the dense PLM;
receiving document embedded contexts for the candidate documents using a dense index; and
outputting a score based on similarity of the received embedded context representations of tokens and document embedded contexts;
wherein the dense PLM is configured to perform a single transformer inference step to produce embedded context representations used for both encoding the sparse representation and reranking the generated candidate documents.

14. The method of claim 13, wherein the input sequence is a query received by an input device audibly or physically.

15. The method of claim 14, wherein the dense PLM comprises a ColBERT model.

16. A method for training an encoder for encoding an input sequence for late interaction information retrieval, the method comprising:
coupling a head to a dense pretrained language model (PLM) to provide the encoder, the head comprising an adapter, a logit layer, and a pooling layer;
freezing the dense PLM;
training the head on an information retrieval task to update parameters of the trained head; wherein said training comprises, for a dataset of input sequences:
the dense PLM receiving the input sequence and embedding context representations of tokens of the input sequence;
the head encoding a sparse representation of the input sequence from the embedded context representations; and
updating parameters of the head to optimize the encoder to approximate the dense PLM.

17. The method of claim 16, wherein said training updates parameters of the adapter of the trained head.

18. The method of claim 17, wherein said training updates parameters of a multilayer perceptron (MLP) of the adapter, the MLP comprising a down-projection layer and an up-projection layer.

19. The method of claim 18, wherein the trained head is an adapted masked language model (MLM) head; and
wherein said training further updates parameters of a bias layer of the logit layer used for generating weights of tokens in a vocabulary with respect to tokens of input sequences.

20. The method of claim 16, wherein said training comprises distillation using the dense PLM as a teacher.

21. The method of claim 20, wherein said training comprises in-batch negative sampling, wherein hard negatives are generated by the dense PLM.

22. The method of claim 20, wherein the distillation comprises minimizing a loss that includes a margin mean squared error (marginMSE) term and a Kullback-Leibler divergence (KLDiv) term between scores produced by the trained head and scores produced by the dense PLM teacher.

23. The method of claim 21, wherein generating hard negatives by the dense PLM comprises selecting, for each query, 20 hard negatives from among the top 1000 candidate documents generated by the dense PLM.

24. A system for encoding an input sequence comprising:
a dense backbone PLM trained to embed context representations of tokens of the input sequence; and
a sparse encoder coupled to the PLM and trained to encode a sparse representation of the input sequence from the embedded context representations using a trained head;
wherein said sparse encoder comprises:
an adapter configured to receive and process the embedded context representations, the adapter comprising a trained MLP;
a logit layer configured to receive the processed context representations and the embedded context representations and map the embedded context representations to a vocabulary; and
a pooling layer configured to generate a sparse representation of the input sequence over the vocabulary from an output of the logit layer;
wherein the sparse encoder is trained while coupled to said PLM and while said PLM is frozen.

25. The system of claim 24, wherein the trained MLP comprises a down-projection layer and an up-projection layer; and
wherein the trained MLP is trained while said PLM is frozen.

26. The system of claim 24, wherein said logit layer comprises a projection layer of the dense PLM and a bias layer;
wherein the trained MLP and the bias layer are trained while said PLM and the projection layer are frozen.

27. The system of claim 26, wherein the dense PLM and the projection layer are pretrained on a trained masked language model (MLM) task.

28. A candidate generation module for generating candidate documents from a corpus of documents, the candidate generation module comprising:
the system for encoding an input sequence according to claim 24;
a sparse index storing sparse representations of documents;
a comparator for comparing the encoded input sequence to sparse representations of documents stored in the sparse index to generate candidate documents from the corpus of documents; and
an output device providing the candidate documents by one or more of (a) audibly via at least one speaker and (b) visually via at least one display.

29. The candidate generation module of claim 28,
wherein the sparse representations of documents in the sparse index were previously generated using context embeddings generated by the dense PLM.

30. The candidate generation module of claim 28, wherein the encoded input sequence is a query.

31. The candidate generation module of claim 28, wherein said comparator scores documents in the sparse index by calculating a dot product between the encoded input sequence and the sparse representations of the documents in the sparse index.

32. The candidate generation module of claim 28, wherein the sparse index comprises an inverted index and the comparator is configured to evaluate the encoded input sequence using at least one of MaxScore and WAND query evaluation.

33. An end-to-end information retrieval system comprising:
the candidate generation module of claim 28; and
a reranking module coupled to said candidate generation module;
wherein said reranking module processes the generated candidate documents using the embedded context representations of the input sequence.

34. The end-to-end information retrieval system of claim 33, wherein said reranking module comprises:
an index of dense vector representations of documents; and
a MaxSim (Maximum Similarity) module that receives the embedded context representations from the dense PLM and reranks the candidates based on similarity of the embedded context representations and dense vector representations of the candidate documents determined using said index.

35. The end-to-end information retrieval system of claim 34, wherein said dense PLM is ColBERT or a variation thereof.
